(19) United States
(12) Patent Application Publication
(10) Pub. No.: US 2026/0030320 A1
(43) Pub. Date: Jan. 29, 2026

(54) BLOCK-BASED ITERATIVE ONE-PASS PROCESSING SYSTEM AND METHOD FOR DETERMINING VARIANCE AND MEAN

(71) Applicant: META PLATFORMS, INC., Menlo Park, CA (US)

(72) Inventor: Xing Cindy Chen, Los Altos, CA (US)

(73) Assignee: META PLATFORMS, INC., Menlo Park, CA (US)

(21) Appl. No.: 19/275,906

(22) Filed: Jul. 21, 2025

Related U.S. Application Data
(60) Provisional application No. 63/674,567, filed on Jul. 23, 2024.

(51) Int. Cl. G06F 17/18; G06T 7/00

(52) U.S. Cl. CPC G06F 17/18; G06T 7/00; G06T 2207/20076

(57) ABSTRACT

A block-based iterative one-pass processing system and method for determining variance and mean is disclosed. Particularly, described is an approach for determining the variance of a data set that leverages a more efficient one-pass technique, that is tailored to maximize the processing capabilities of block-based hardware by processing an entire block of data at one time. Input data is separated into blocks of data and the block-based hardware processes each block until all of the blocks have been processed. For each block, computations may be performed to determine values specific to that block (e.g., mean, variance, etc.). Running values may be updated as each block is processed to include the resulting values from the current block.

### CROSS-REFERENCE TO RELATED APPLICATION

This application claims priority to and benefit of U.S. provisional patent application No. 63/674,567 filed Jul. 23, 2024, which is herein incorporated by reference.

### BACKGROUND

Generally, it is desirable to be able to process multiple data points simultaneously to maximize the efficiency of data processing tasks (as one example of such a task is determining the variance of a given dataset, as is described in further detail below). One possible approach is to process the data in parallel using multiple processors. However, with this approach, the amount of data that can be processed at a single time depends on the number of processors that are available, and to improve the efficiency of the data processing, additional processors need to be introduced.

Another approach is to leverage block-based hardware to process multiple data points at once without needing to leverage additional processors to process data in parallel. The term “block-based hardware” as used herein may generally refer to any single hardware processing component that is configured to process a block of data (a “block” of data as used herein may generally refer to a group of multiple data points) at a single time. For example, block-based hardware may include an application-specific integrated circuit (ASIC) and/or any other similar type of single hardware component. Block-based hardware may be configured to perform vector processing, which entails processing numerous data components at once. Specifically, the hardware component is used to execute the same operations on numerous data elements concurrently. This makes block-based hardware ideal for applications where many data points are processed at once, such as image processing and graphics rendering.

Hardware components configured for vector processing provide several technical advantages. First, vector processing can achieve high performance by exploiting data parallelism and reducing memory access (thus, the hardware can perform computations faster than traditional processors, particularly for tasks that involve repeated operations on large datasets). Second, hardware configured to perform vector processing can handle larger datasets without sacrificing performance. Third, such hardware only requires a limited instruction set optimized for numerical computations. These are merely a few of the benefits of hardware configured for vector processing and other benefits may be possible.

### BRIEF DESCRIPTION OF THE DRAWINGS

FIG. 1 illustrates a use case for a block-based iterative one-pass processing method for determining variance and mean in accordance with one or more embodiments of the disclosure.

FIGS. 2A-2C illustrate flow diagrams for a block-based iterative one-pass processing method for determining variance and mean in accordance with one or more embodiments of the disclosure.

FIG. 3 illustrates a method for a block-based iterative one-pass processing method for determining variance and mean in accordance with one or more embodiments of the disclosure.

FIG. 4 illustrates exemplary block-based hardware on which the iterative one-pass processing method for determining variance and mean may be implemented in accordance with one or more embodiments of the disclosure.

FIG. 5 illustrates a system for a block-based iterative one-pass processing method for determining variance and mean in accordance with one or more embodiments of the disclosure.

FIG. 6 schematically illustrates an example architecture of a computer system associated with a block-based iterative one-pass processing method for determining variance and mean in accordance with one or more embodiments of the disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

### Overview

Disclosed herein is a block-based iterative one-pass processing system and method for determining variance and mean. Particularly, described is an approach for determining the variance of a data set that leverages a more efficient one-pass technique further tailored to maximize the processing capabilities of block-based hardware by processing an entire block of data at a time. This approach represents a technical improvement over existing algorithms that use a two-pass technique and/or only process single data points rather than entire blocks of data (these more inefficient conventional techniques are outlined below), both of which result in inefficient hardware usage and add processing delays. In contrast with these more inefficient techniques, the block-based iterative one-pass processing method described herein not only improves processing efficiency and reduces processing time (because more data can be processed by the same hardware at a single time), but also reduces hardware usage by allowing more data to be processed by a single hardware component (whereas with the conventional techniques, parallel processing with multiple hardware components would be required to reduce the processing time when processing the same amount of data).

Generally, the computation of the variance of a finite population of n data points may be defined as:

$$variance = {s}^{2} = \frac{{\sum }_{i = 1}^{n} {( {x}_{i} - \overline{x} )}^{2}}{n} ,$$

where x̅ is the mean of the samples:

$$\overline{x} = \frac{{\sum }_{j = 1}^{n} {x}_{j}}{n} .$$

With a conventional two-pass algorithm, the variance is computed by first computing the mean and then computing the sum of squares of the differences between the sample and the mean. This approach is numerically stable but requires passing the data set twice, resulting in inefficient data processing, especially when the data set is large and the local memory of the processing hardware is unable to store all of the data.

An improvement over this two-pass algorithm is a one-pass algorithm. The one-pass only requires the data to be passed through the hardware once to determine the variance. The above definition of variance can be rewritten to the following equivalent form:

$${σ}^{2} = \overline{( {x}^{2} )} - {\overline{x}}^{2} = \frac{{\sum }_{i = 1}^{N} {x}_{i}^{2} - {( {\sum }_{i = 1}^{N} {x}_{i} )}^{2} / N}{N}$$

Using this formula, a system could determine both sum(x) and sum(x²) accumulated in the same pass, and the final variance may be determined as: Variance=sum(x²)/N−(sum(x)/N)².

This one-pass approach can be more efficiently implemented on block-based hardware but is less numerically stable than the two-pass approach, especially when the data set is large and the sum of squares becomes an increasingly large value. The more precise cause of instability is when the sum of the squared values and the sum of the values squared divided by the number of values are both large numbers. In other words, the instability is not necessarily due to the data set being large, but instead may result from the data values themselves being too large.

Another approach that improves upon this conventional one-pass approach mentioned above is the shifted-data one-pass algorithm. The shifted-data one-pass algorithm improves on the standard one-pass algorithm by “shifting” all the input data by a constant “K,” since Var(x−K)=Var(x). This K value, however, needs to be set by a user. Having a K value closer to the mean of the data sample results in a more stable algorithm. This algorithm is one-pass, easy to implement and suitable for block-based hardware. However, the stability is dependent on the choice of K and the standard practice is to let K be the first or a random sample of the dataset. Given that some datasets tend to be sparse, the probability of choosing K as zero is high, hindering the stability of the algorithm. In other words, the algorithm is more stable, but there may be difficulties in determining the K value to use.

The Welford algorithm further improves upon the shifted-data one-pass algorithm. The Welford algorithm is an iterative algorithm that maintains a current “running mean” that is updated as the hardware processes each data point. The algorithm subtracts the running mean from the current sum of squared difference as individual data points are received to be processed by the hardware one-by-one. Accordingly, the value of the sum of squares is not too large and therefore is numerically more stable. The Welford algorithm is also a one-pass approach and, therefore, an efficient algorithm (relative to the standard two-pass approach). However, implementing the Welford algorithm onto block-based hardware is highly inefficient because the Welford algorithm can only process one row at a time on block-based vector hardware, while block-based hardware is capable and most efficient in processing multiple rows (e.g., a block of data) at a time.

In contrast with these conventional techniques described above, the block-based hardware processing approach described herein represents a technical improvement by leveraging the running mean and variance concept of the Welford algorithm with a block-based processing approach that more efficiently uses block-based hardware to improve processing times for variance computations. That is, the block-based hardware can iteratively update the current running mean and variance based on the blocks that have already been processed with the mean and variance computed for the current block being processed.

To continuously update the running mean and variance values, the following equations may be used by the block-based hardware to combine the mean and sum of squared difference of two sample sets, A and B. In the below equations, n_{A} and n_{B} are number of samples/elements in sets A and B, respectively. n_{AB} is the total number of samples of combined set AB. Delta (δ) is the difference between the mean of set B and the mean of set A. x̅_{AB} is the mean of the combined set AB. x̅_{A} is the mean of A and x̅_{B} is the mean of B. “M₂” may refer to a “scaled variance” (e.g., variance scaled by the number of samples). Accordingly, Equation 4 calculates the scaled variance of set AB as the scaled variance of set A plus the scaled variance of set B plus an “adjustment term,” which is a function of delta and the number of samples of A, B, and AB.

$${n}_{AB} = {n}_{A} + {n}_{B} \qquad ( Equation 1 )$$

$$δ = {\overline{x}}_{B} - {\overline{x}}_{A} \qquad ( Equation 2 )$$

$${\overline{x}}_{AB} = {\overline{x}}_{A} + δ * \frac{{n}_{B}}{{n}_{AB}} \qquad ( Equation 3 )$$

$${M}_{2 AB} = {M}_{2 A} + {M}_{2 B} + {δ}^{2} * \frac{{n}_{A} {n}_{B}}{{n}_{AB}} , where \frac{{M}_{2}}{{n}_{AB}} is the variance . \qquad ( Equation 4 )$$

When using hardware and instructions to process “nb” rows at a time (or a block with width “w,” and height “nb”, and nb>1), then at the i^{th} iteration, the algorithm in accordance with the present disclosure combines the two sets A and B, where n_{A}=(i−1)*nb and n_{B}=nb.

In one or more embodiments, the block-based hardware may perform the variance computations as described herein as follows. First, the block-based hardware may receive the input data for which it is desired to determine the variance. The block-based hardware may separate the input data into individual blocks. In some instances, the input data may be received by the block-based hardware already separated into the blocks to be processed by the block-based hardware (for example, the blocks may be generated upstream in the data processing pipeline by another system or hardware element).

The block-based hardware may first initialize the following registers to zeros: SumPrev=0, MeanPrev=0, M2Prev=0 (the names are merely exemplary). The block-based hardware may then begin processing individual blocks of the input data. For each block, the sum of the data points in the block, the mean of the data points in the block, and variance of the block may be computed. For example, the sum may be computed as the column wise sum of the datapoints in the current block. The mean may be computed as a product of the sum for the block divided by the number of data points in the block (the terms data points and entries may be used interchangeably herein). The “M2” value for the current block may be computed as a column wise sum of squares of a “Diff” value. The “Diff” value may be determined as the difference between a value “x” and the mean of the current block.

Once a current block is processed, the resulting values may be merged with the existing running values (for the first block that is processed, the resulting values for that block become the initial running values). To perform this merging to update the running values, the following steps may be performed. First, a delta value may be computed as the difference between the mean for the current block and the mean for the prior block. This delta value may then be squared. The cumulative sum may be updated as the previous cumulative sum plus the current sum. The cumulative mean may be computed as the product of the cumulative sum and an v1[i] value (for iteration i). The M2 cumulative value may be determined as M2 cumulative+=M2 for the current block, and M2_cumulative+=the product of delta squared and v2[i] (for iteration i).

To further improve the efficiency of the processing performed by the block-based hardware, the v1 and v2 values may be pre-computed, rather than being computed through every iteration of block processing by the block-based hardware. For example, v1 may be initialized as

$$v 1 [ i ] = \frac{1}{{n}_{ab}} = \frac{1}{( ( i + 1 ) * {n}_{b} )}$$

where n_{ab}=nₐ+n_b, and i is from 0 to the maximum number of blocks minus one. Further, v2 may be initialized with a vector:

$$v 2 [ i ] = i * {n}_{b} * \frac{{n}_{b}}{( i + 1 ) * {n}_{b}} = {n}_{b} * \frac{i}{i + 1}$$

and i is from 0 to the maximum number of blocks minus one.

Any variable names presented above are merely exemplary and not intended to be limiting. Additionally, this pseudocode represents only one exemplary implementation of the block-based hardware approach described herein and is also not intended to be limiting.

### ILLUSTRATIVE EMBODIMENTS AND USE CASES

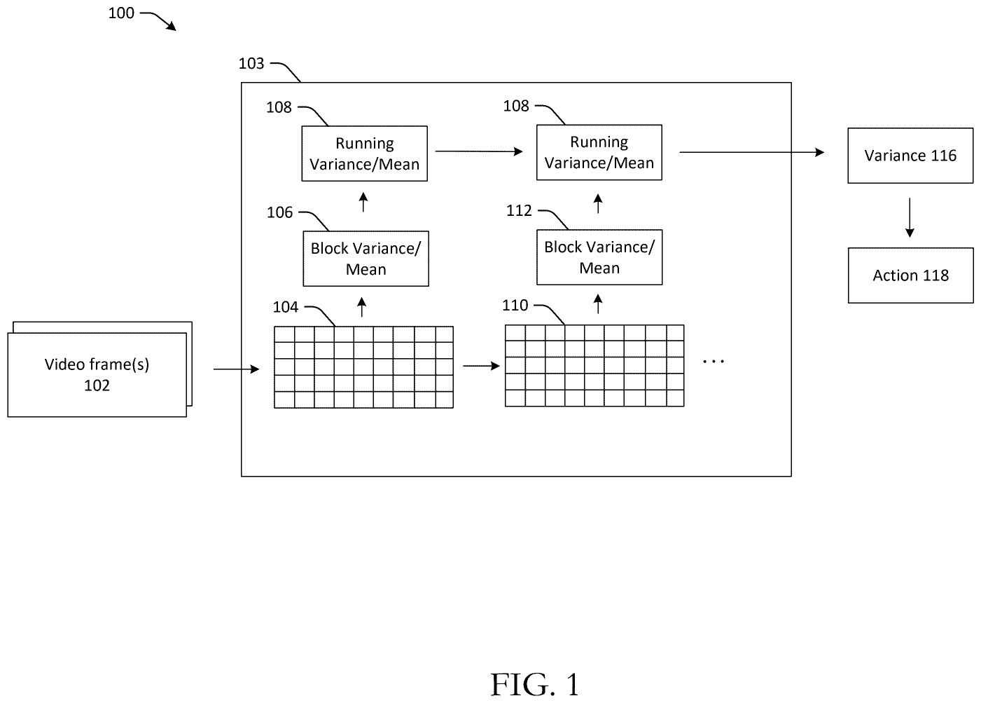

FIG. 1 illustrates a use case 100 for a block-based iterative one-pass processing method for determining variance and mean. Particularly, the use case 100 involves determining variance in pixel values across a series of video frames 102. For example, in video processing, variance computation may be used to analyze motion and identify regions of change within a video sequence. Variance quantifies the variability or spread of pixel values over time or across a spatial region. This information can be used for various purposes, including background subtraction, motion detection, and video stabilization. The use case 100 shows one application of variance data, however, and is not intended to be limiting. Variance computations may be performed for any other data set (other non-limiting examples are provided elsewhere herein).

The use case 100 begins with input data being provided to block-based hardware 103 (which may be any block-based hardware described herein or otherwise). In this instance, the input data is data associated with video frames 102. This input data may be provided in any suitable format (e.g., the video frames 102 themselves, matrices (or other forms of multiple data points) including the pixel values for the video frames 102, etc.).

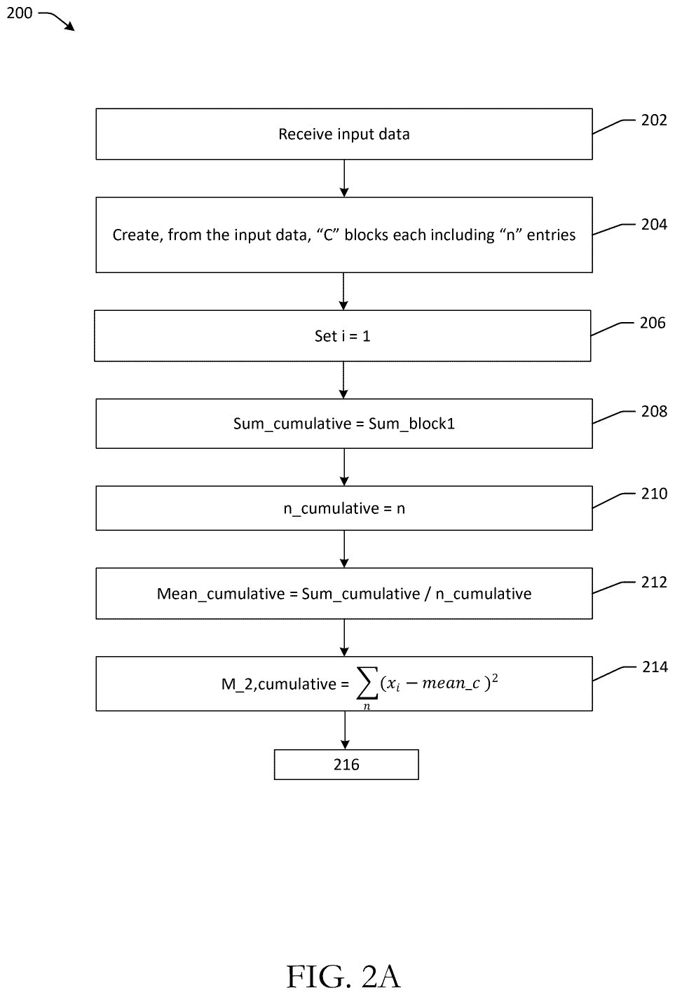

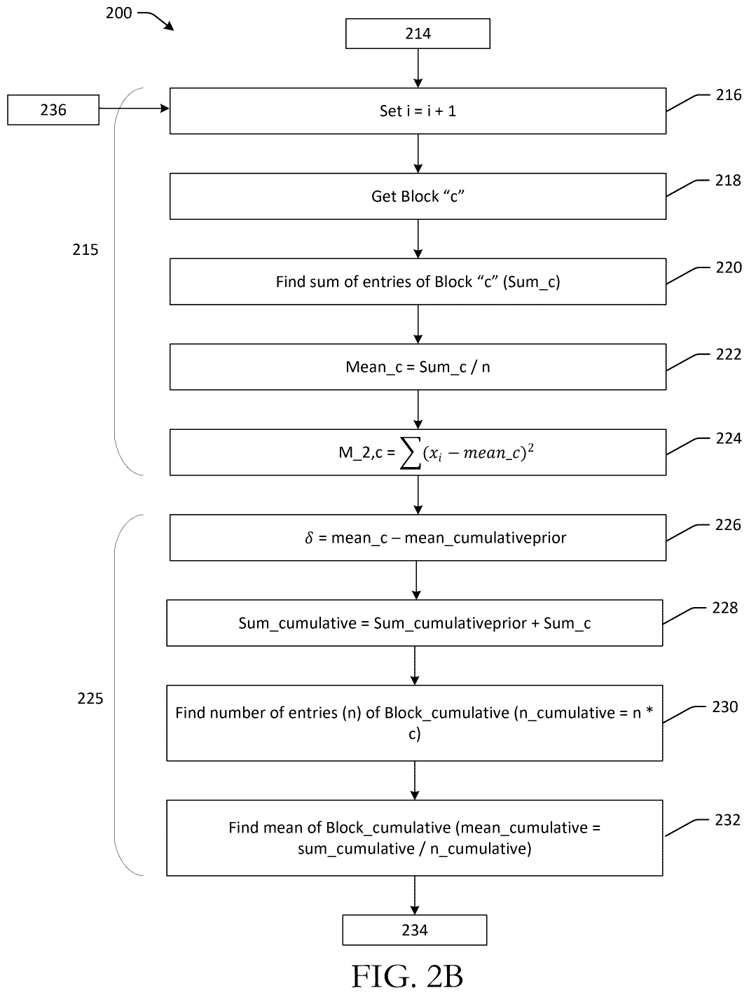

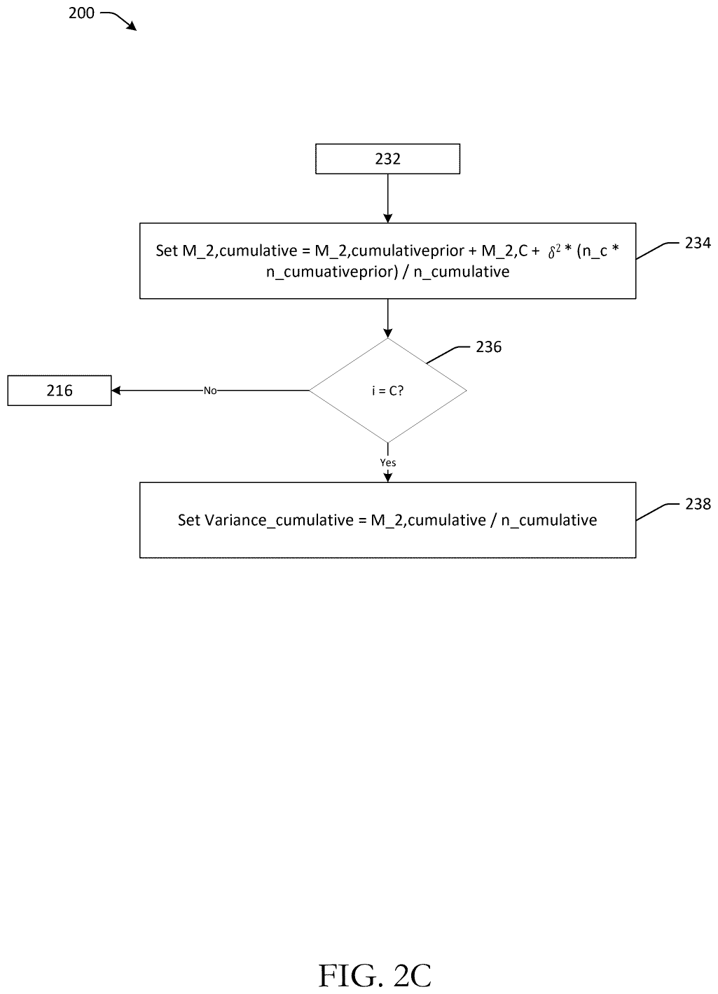

The block-based hardware 103 may separate the input data into blocks. In the simplified example shown in FIG. 1, a first block 104 and a second block 110 are shown, however, the input data may be separated into any number of blocks depending on the amount of input data and the size of the blocks that are generated. In some instances, the input data may be provided to the block-based hardware already separated into blocks that are ready for processing by the block-based hardware 103. The specific process for determining the current variance and mean values for each of the individual blocks (and/or any other values used for variance computations), as well as the process for merging the resulting variance and mean values with the running (also referred to as cumulative herein) values 108, are described in further detail in FIGS. 2A-2C.

Once the input data is separated into the individual blocks, an iterative process is undertaken by the block-based hardware 103 to process each of the blocks (e.g., the first block 104 and the second block 110) until all of the blocks have been processed. Specifically, the process entails calculating block mean and variance values (as well as any other values necessary for determining the mean and variance) for each of the blocks and then merging those values with the running values 108 for all of the processed blocks. In the example shown in FIG. 1, current block values 106 (which may include any of the types of values mentioned above) are first determined for the first block 104. These values become the running values 108 by default, given that the first block 104 is the first to be processed by the block-based hardware 103. The current block values 112 for the second block are then determined 110, and then these values are merged with the running values 108, such that the running values 108 then account for both the block variance and mean values 106 for the first block 104 and the current block values 112 for the second block 110. As indicated above, one advantage of the technique described herein is that blocks of data can be processed on one hardware component, while ensuring that the computations for each block are combined into the running values 108 values for all of the blocks that have been processed.

After all of the blocks have been processed, the variance 116 that is output by the block-based hardware 103 for the input data is based on the variance value in the running variance and mean values 108. The variance 116 may then be used by a separate system to perform any number of actions. As mentioned above, in the context of video processing, the variance 116 for various purposes, including background subtraction, motion detection, and video stabilization. In some instances, a separate system may automatically perform these or other types of actions based on the variance 116 produced by the block-based hardware 103.

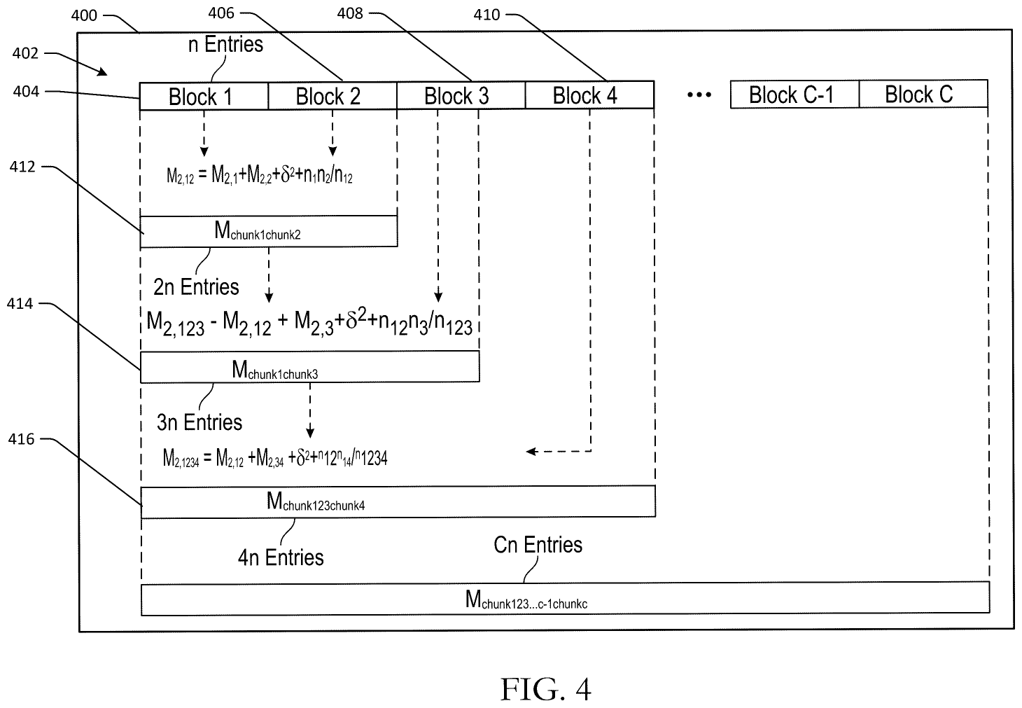

FIGS. 2A-2C illustrate a flow diagram 200 for a block-based iterative one-pass processing method for determining variance and mean. Specifically, FIG. 2A illustrates a portion of the flow diagram 200 including variable initialization steps. FIGS. 2B-2C illustrate a portion of the flow diagram 200 including steps for mean and variance computations for a current data block being processed, as well as steps for merging the mean and variance computations for the current data block with the running mean and variance computations for all blocks processed thus far. Any of the steps shown in FIGS. 2A-2B may be performed by block-based hardware, which may include any hardware that is configured to efficiently process blocks of data at once, such as application-specific integrated circuits (ASICs), etc. An example of such hardware performing some of the processes in the flow diagram 200 is shown in FIG. 4.

Beginning with FIG. 2A, operation 202 involves receiving input data. The input data may be received from any type of data source and may be in any form, depending on the use case for which the mean and variance values are determined. The input data includes numerous data points and the type of information represented by the data may differ depending on the type of input data. For example, if the input data is representative of video frames of video content, the individual data values may be pixel values for the pixels found in each of the video frames.

Operation 204 involves separating the input data into blocks (or chunks), with each block including “n” number of data values or entries. As mentioned above, the technique described herein is tailored to maximize the capabilities of block-based hardware, and therefore larger blocks of data are processed at once, rather than the conventional techniques mentioned above that process single data points at a time. In some instances, the input data that is received in operation 204 may already be separated into individual blocks that are ready to be processed by the block-based hardware. Accordingly, operation 204 may, in some instances, occur before operation 202.

As mentioned above, the conventional Welford algorithm is only configured to process one single data point (one element) per iteration, so the algorithm integrating one datapoint into the running value(s) every iteration, which is why this approach is not suitable/efficient for a vector-processor (or block-based processor). The approach described herein, in contrast, integrates N samples (where N is the number of elements for which the vector processor can find the mean and variances at a time). As an example, to compute the variance of 128 elements, the Welford algorithm would take at least 128 cycles, but using the approach described herein method, if the block-based hardware can compute the variance of 64 elements in 10 cycles, the total number of cycles will be 10*2+cycles to combine the two sets.

The blocks may be any size (including any number of data points (or entries), however, the blocks that are created for one set of input data may preferably be separated into equally sized blocks to simplify the algorithm. For example, by having equally sized blocks, the number of entries for any given block may be the same regardless of the block that is currently being processed (this number of entries value is used for some of the computations described herein). Therefore, this value may be a constant, rather than a dynamic value that needs to be recomputed for every block that is processed. The size of the blocks may depend on the configuration of the block-based hardware that is used to perform the mean and variance computation. The sizes of the blocks, however, do not necessarily need to correspond to the maximum block processing size of the hardware being used.

Operations 206-214 involve initializing and defining various variables used in the steps shown in FIGS. 2B-2C. Specifically, operation 206 involves setting an index value (for example, a value used to track the current number block being processed) to “1”. Operation 208 involves setting a cumulative (it should be noted that the terms “cumulative” and “running” may be used to refer to the same value herein) sum value to a sum of the data values in the current block (the first block). Operation 210 involves setting a value representing the cumulative number of entries to the number of entries in the current block. Operation 212 involves setting a cumulative mean value to the cumulative sum value divided by the cumulative number of entries value. Operation 214 involves setting an “M2” cumulative value (as mentioned above, the variance is determined as an M2 value divided by a number of entries) as Σₙ(xᵢ−mean_c)².

Turning to FIGS. 2B-2C, FIG. 2B begins with sub-processes 215, in which the computations for the current block being processed are performed. Operation 216 involves incrementing the value of “i” (indicating that a new block is being processed by the block-based hardware. Likewise, the new block to be processed is obtained by (or otherwise provided to) the block-based hardware at operation 218. Operation 220 involves finding the sum of the data points included in the current block. Operation 222 involves determining the mean of the data points in the current block as the sum determined in operation 220 divided by the number of entries. Finally, operation 224 involves determining the currentM2 value as Σ(xᵢ−mean_c)².

FIG. 2B then continues with sub-processes 225 in which the mean and variance determined for the current block are “merged” into the running mean and variance for all of the processed blocks thus far. Operation 226 involves determining a delta value as the difference between the current mean and the prior cumulative mean. Any reference to “prior cumulative” or “cumulative prior” may refer to the cumulative value before the results of the current block that is being processed are merged into any cumulative value. Operation 228 involves determining a new cumulative sum as the prior cumulative sum added to the sum for the current block. Operation 230 involves determining the number of entries in the cumulative blocks. If the block sizes are identical, this value may be the number of entries in one block multiplied by the number of blocks processed. Operation 232 involves determining the mean of the cumulative blocks. This value may be the cumulative sum divided by the cumulative number of entries determined in operation 230.

Continuing with FIG. 2C, the cumulative “M2” value used for variance computation may be determined in operation 234 as the prior cumulative M2 value, plus the square of the [ ] value determined in operation 226, multiplied by the product of the number of entries in the current block and the prior cumulative number of entries, which is divided by the cumulative number of entries (shown above as Equation 2). After the cumulative M2 value is determined at operation 234, condition 236 involves determining if the index value is currently equal to the number of blocks to be processed (that is, determining whether all of the blocks have been processed). If not all of the blocks have been processed, then the flow diagram 200 loops back to operation 216, and the next block is processed by the block-based hardware. This loop iterates until condition 236 is met. At this point, the flow diagram 200 proceeds to operation 238, and the cumulative variance value (the ultimate output of the flow diagram 200 is determined to be the cumulative M2 value divided by the cumulative number of entries in the processed blocks.

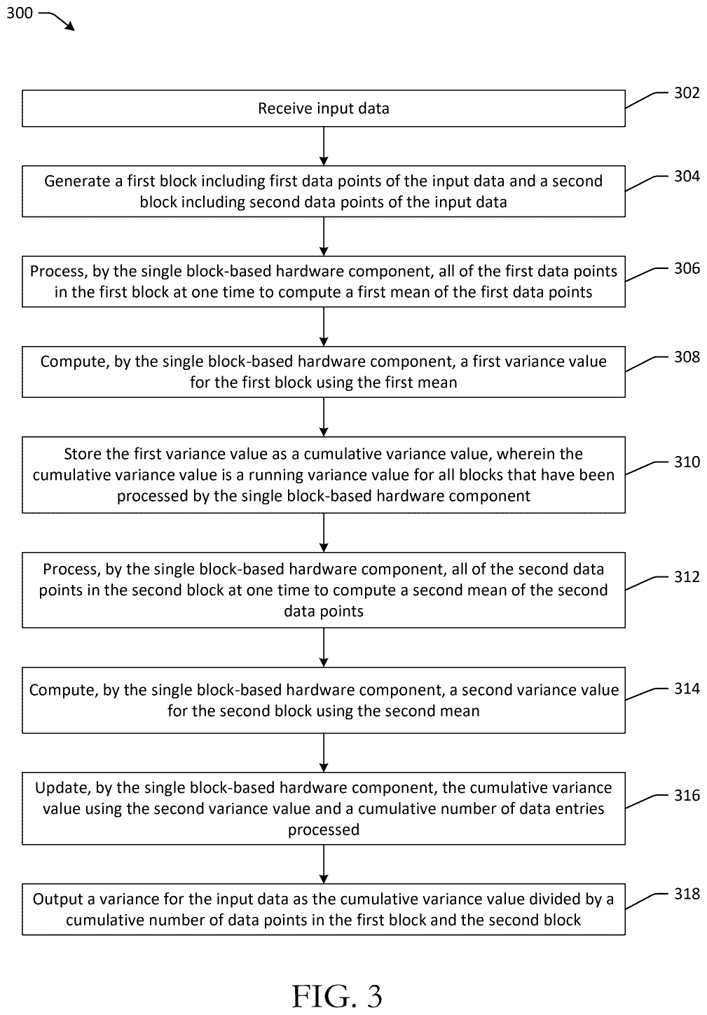

FIG. 3 depicts an example method 300 for block-based iterative one-pass processing for determining variance and mean. Some or all of the blocks of the process flows or methods in this disclosure may be performed in a distributed manner across any number of devices or systems (for example, client system 530, backend system 560, block-based hardware 103, 400, and/or 562, computing system 600, etc.). The operations of the method 300 may be optional and may be performed in a different order.

At block 302 of the method 300, computer-executable instructions stored in memory of a system or device may be executed to receive input data.

At block 304 of the method 300, computer-executable instructions stored in memory of a system or device may be executed to generate a first block including first data points of the input data and a second block including second data points of the input data;

At block 306 of the method 300, computer-executable instructions stored in memory of a system or device may be executed to process, by the single block-based hardware component (such as block-based hardware 103, 400, and/or 562, or any other block-based hardware described herein or otherwise), all of the first data points in the first block at one time to compute a first mean of the first data points. At block 308 of the method 300, computer-executable instructions stored in memory of a system or device may be executed to compute, by the single block-based hardware component, a first variance value for the first block using the first mean. For example, the computation may include the sub-processes 215 shown in FIG. 2B. The “first variance value” may refer to the “M2” value (see operation 224 of FIG. 2B, for example) that is later used to compute the final variance for the entire input data set.

At block 310 of the method 300, computer-executable instructions stored in memory of a system or device may be executed to store the first variance value as a cumulative variance value, wherein the cumulative variance value is a running variance value for all blocks that have been processed by the single block-based hardware component. For example, the cumulative variance value may be the cumulative M2 value computed in operation 234 of FIG. 2C.

At block 312 of the method 300, computer-executable instructions stored in memory of a system or device may be executed to process, by the single block-based hardware component, all of the second data points in the second block at one time to compute a second mean of the second data points. At block 314 of the method 300, computer-executable instructions stored in memory of a system or device may be executed to compute, by the single block-based hardware component, a second variance value for the second block using the second mean. For example, the computation may include the sub-processes 215 shown in FIG. 2B. The “second variance value” may also refer to the “M2” value (see operation 224 of FIG. 2B, for example) that is later used to compute the final variance for the entire input data set. That is, this value is computed by the block-based hardware for each block that is processed.

At block 316 of the method 300, computer-executable instructions stored in memory of a system or device may be executed to update, by the single block-based hardware component, the cumulative variance value using the second variance value and a cumulative number of data entries processed.

At block 318 of the method 300, computer-executable instructions stored in memory of a system or device may be executed to output a variance for the input data as the cumulative variance value divided by a cumulative number of data points in the first block and the second block (for example, operation 238 of FIG. 2C).

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure. The above-described embodiments and additional and/or alternative embodiments of the disclosure will be described in detail hereinafter through reference to the accompanying drawings.

One or more operations of the methods, process flows, or use cases of FIGS. 1-3 may have been described above as being performed by a computing system, or more specifically, by one or more program module(s), applications, or the like executing on a device. It should be appreciated, however, that any of the operations of the methods, process flows, or use cases of FIGS. 1-3 may be performed, at least in part, in a distributed manner by one or more other devices, or more specifically, by one or more program module(s), applications, or the like executing on such devices. In addition, it should be appreciated that processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-3 may be described in the context of the illustrative devices, it should be appreciated that such operations may be implemented in connection with numerous other device configurations.

The operations described and depicted in the illustrative methods, process flows, and use cases of FIGS. 1-3 may be carried out or performed in any suitable order, such as the depicted orders, as desired in various example embodiments of the disclosure. Additionally, in certain example embodiments, at least a portion of the operations may be carried out in parallel. Furthermore, in certain example embodiments, less, more, or different operations than those depicted in FIGS. 1-3 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by the execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Computer Architecture

FIG. 4 illustrates exemplary block-based hardware 400 on which the iterative one-pass processing method for determining variance and mean may be implemented. Specifically, FIG. 4 shows the block-based hardware 400 as being an ASIC. However, this is not intended to be limiting and the block-based hardware may be any type of hardware that is capable of processing blocks of data at a time.

As mentioned above, the technique described herein is advantageous and represents an improvement over existing techniques in that a single hardware component (such as the ASIC shown in FIG. 4 can perform the one-pass approach, while further improving the efficiency of the approach by processing blocks of data at a time, rather than processing rows of data one-by-one, as is the case with the Welford algorithm. As indicated above, this not only improves processing efficiency and reduces processing time (because more data can be processed by the same hardware at a single time), but also reduces hardware usage by allowing more data to be processed by a single hardware component. It is still possible to leverage multiple of such hardware components to further improve the efficiency of the process (for example, multiple ASICs (or other types of block-based hardware) may process blocks in parallel, however, each of these individual hardware components can process more data (thereby reducing the number of hardware components that are required to be used to process the same amount of data in parallel (if parallel processing is used). As indicated above, this block-based hardware 400 contrasts with other types of processors that require multiple of such processors to be provided different data elements to perform parallel processing of the data, rather than any single one of the processors being configured to process all of the data at once.

FIG. 4 shows an example in which the block-based hardware 400 is processing one set of input data 402 that is separated into individual blocks (for example, block 404, block 406, block 408, block 410, etc.). Each of the blocks includes “n” entries (data points). During the processing of the input data 402, the block-based hardware 400 undertakes an iterative process by which it processes a block of the input data (for example, in a manner consistent with the steps shown in FIGS. 2A-2C), determines certain values for that block, and then updated a running set of values based on the values computed for that block. In the example shown in FIG. 4, the first block 404 and the second block 406 are processed. The values computed from the first block 404 and the second block 406 may be merged (again, using the techniques described in FIGS. 2B-2C and shown above in Equations 1-4) into a first running set of values 412. For example, this running set of values may include the “M2” value mentioned elsewhere herein that is used to determine the final variance for the input data 402. The running set of values 412 may also include other types of values, such as sum, mean, etc. This process continues with the third block 408. The resulting values from the third block 408 are merged with the first running set of values 412 to update the first running set of values 412 to a second running set of values 414. The same process is performed for the fourth block 410 to produce a third running set of values 416. This iterative process is repeated until all of the blocks of the input data 402 have been processed.

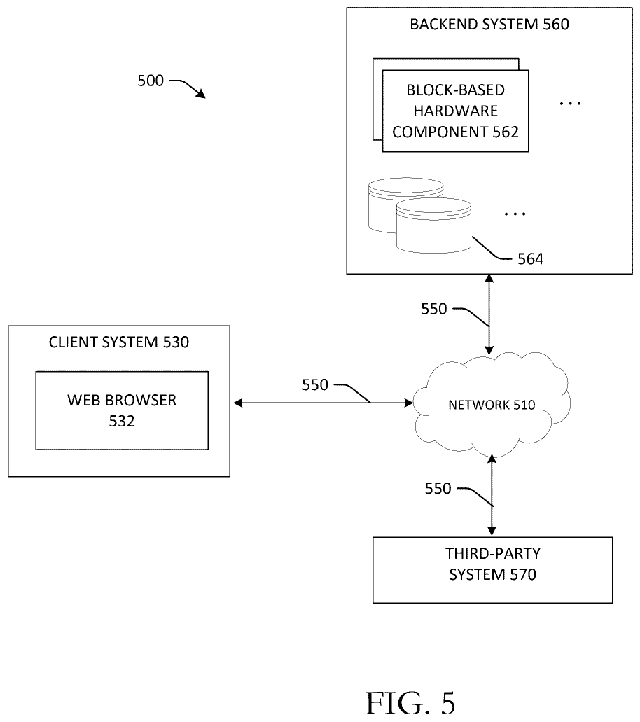

FIG. 5 illustrates an example network environment 500 associated with a block-based iterative one-pass processing system for determining variance and mean as described herein. Network environment 500 may implement one or more aspects of the flow diagrams 200 and the method 300 already discussed.

Network environment 500 includes a client system 530, a backend system 560, and a third-party system 570 connected to each other by a network 510. Although the figures illustrate a particular arrangement of client system 530, backend system 560, third-party system 570, and network 510, this disclosure contemplates any suitable arrangement of client system 530, backend system 560, third-party system 570, and network 510. As an example and not by way of limitation, two or more of client system 530, backend system 560, and third-party system 570 may be connected to each other directly, bypassing network 510. As another example, two or more of client system 530, backend system 560, and third-party system 570 may be physically or logically co-located with each other in whole or in part. Moreover, although FIG. 5 illustrates a particular number of client systems 530, backend systems 560, third-party systems 570, and networks 510, this disclosure contemplates any suitable number of client systems 530, backend systems 560, third-party systems 570, and networks 510. As an example and not by way of limitation, network environment 500 may include multiple client systems 530, backend systems 560, third-party systems 570, and networks 510. Furthermore, although reference is made specifically to a backend system 560, the block-based iterative one-pass processing technique described herein may be applicable to any other type of system as well.

This disclosure contemplates any suitable network 510. As an example and not by way of limitation, one or more portions of network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these.

Network 510 may include one or more networks 510. Links 550 may connect client system 530, backend system 560, and third-party system 570 to communication network 510 or to each other. This disclosure contemplates any suitable links 550. In particular examples, one or more links 550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout network environment 500. One or more first links 550 may differ in one or more respects from one or more second links 550.

In particular examples, client system 530 may be an electronic device including hardware, software, or embedded logic components or a combination of two or more such components and capable of carrying out the appropriate functionalities implemented or supported by client system 530. As an example and not by way of limitation, a client system 530 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 530. A client system 530 may enable a network user at client system 530 to access network 510. A client system 530 may enable its user to communicate with other users at other client systems 530.

In particular examples, client system 530 may include a web browser 532, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 530 may enter a Uniform Resource Locator (URL) or other address directing the web browser 532 to a particular server (such as server 562, or a server associated with a third-party system 570), and the web browser 532 may generate a Hyper Text Transfer Protocol (HTTP) request and communicate the HTTP request to server. The server may accept the HTTP request and communicate to client system 530 one or more Hyper Text Markup Language (HTML) files responsive to the HTTP request. Client system 530 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular desires. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular examples, the network environment 500 may include backend system 560 including one or more block-based hardware components 562 (which may be block-based hardware 400 or any other block-based hardware described herein or otherwise). Although FIG. 5 shows the block-based hardware components 562 being associated with a backend system 560, the block based hardware components 562 may also be located anywhere else in the networking environment 500. Data stores 564 may be used to store various types of information. In particular examples, the information stored in data stores 564 may be organized according to specific data structures. In particular examples, each data store 564 may be a relational, columnar, correlation, or other suitable database.

Although this disclosure describes or illustrates particular types of databases, this disclosure contemplates any suitable types of databases. Particular examples may provide interfaces that enable a client system 530, a backend system 560, or a third-party system 570 to manage, retrieve, modify, add, or delete the information stored in data store 564.

In particular examples, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating backend system 560.

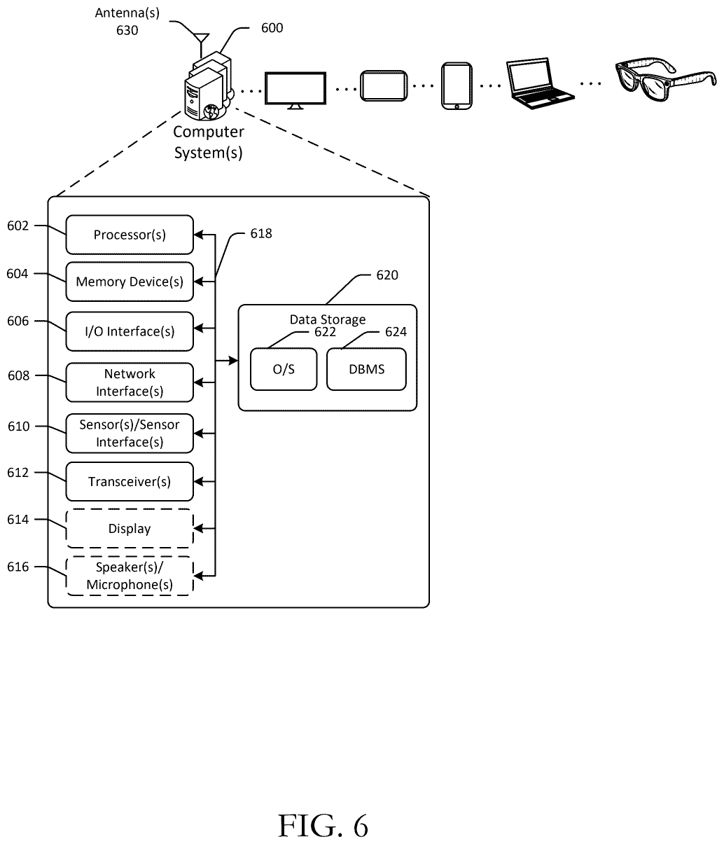

FIG. 6 is a schematic block diagram of one or more illustrative computing system(s) 600 in accordance with one or more example embodiments of the disclosure. The computing system(s) 600 may include any suitable computing device including, but not limited to, a server system, a voice interaction device, a mobile device such as a smartphone, a tablet, an e-reader, a wearable device, or the like; a desktop computer; a laptop computer; a content streaming device; or the like. The computing system(s) 600 may correspond to an illustrative device configuration for the device(s) of FIGS. 1-5 (such as client system 530, backend system 560, third-party system 570, and systems and/or devices used to perform or facilitate the performance of any processes associated with the flow diagrams of FIGS. 2-3, etc.).

The computing system(s) 600 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing system(s) 600 may include one or more processors (processor(s)) 602, one or more memory devices 604 (also referred to herein as memory 604), one or more input/output (I/O) interface(s) 606, one or more network interface(s) 608, one or more sensor(s) or sensor interface(s) 610, one or more transceiver(s) 612, one or more optional display(s) 614, one or more optional microphone(s) 616, and data storage 620. The computing system(s) 600 may further include one or more bus(es) 618 that functionally couple various components of the computing system(s) 600. The computing system(s) 600 may further include one or more antenna(s) 630 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 618 may include at least one of a system bus, a memory bus, an address bus, or a message bus, and may permit the exchange of information (e.g., data (including computer-executable code), signaling, etc.) between various components of the computing system(s) 600. The bus(es) 618 may include, without limitation, a memory bus or a memory controller, a peripheral bus, an accelerated graphics port, and so forth. The bus(es) 618 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 604 of the computing system(s) 600 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 604 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 604 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 620 may include removable storage and/or non-removable storage including, but not limited to, magnetic storage, optical disk storage, and/or tape storage. The data storage 620 may provide non-volatile storage of computer-executable instructions and other data. The memory 604 and the data storage 620, removable and/or non-removable, are examples of computer-readable storage media (CRSM) as that term is used herein.

The data storage 620 may store computer-executable code, instructions, or the like that may be loadable into the memory 604 and executable by the processor(s) 602 to cause the processor(s) 602 to perform or initiate various operations. The data storage 620 may additionally store data that may be copied to the memory 604 for use by the processor(s) 602 during the execution of the computer-executable instructions. Moreover, output data generated as a result of execution of the computer-executable instructions by the processor(s) 602 may be stored initially in the memory 604, and may ultimately be copied to the data storage 620 for non-volatile storage.

More specifically, the data storage 620 may store one or more operating systems (O/S) 622; one or more database management systems (DBMS) 624; and one or more program module(s), applications, engines, computer-executable code, scripts, or the like. Some or all of these module(s) may be sub-module(s). Any of the components depicted as being stored in the data storage 620 may include any combination of software, firmware, and/or hardware. The software and/or firmware may include computer-executable code, instructions, or the like that may be loaded into the memory 604 for execution by one or more of the processor(s) 602. Any of the components depicted as being stored in the data storage 620 may support functionality described in reference to corresponding components named earlier in this disclosure.

The data storage 620 may further store various types of data utilized by the components of the computing system(s) 600. Any data stored in the data storage 620 may be loaded into the memory 604 for use by the processor(s) 602 in executing computer-executable code. In addition, any data depicted as being stored in the data storage 620 may potentially be stored in one or more datastore(s) and may be accessed via the DBMS 624 and loaded in the memory 604 for use by the processor(s) 602 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 602 may be configured to access the memory 604 and execute the computer-executable instructions loaded therein. For example, the processor(s) 602 may be configured to execute the computer-executable instructions of the various program module(s), applications, engines, or the like of the computing system(s) 600 to cause or facilitate various operations to be performed in accordance with one or more embodiments of the disclosure. The processor(s) 602 may include any suitable processing unit capable of accepting data as input, processing the input data in accordance with stored computer-executable instructions, and generating output data. The processor(s) 602 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 602 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 602 may be capable of supporting any of a variety of instruction sets.

Referring now to other illustrative components depicted as being stored in the data storage 620, the O/S 622 may be loaded from the data storage 620 into the memory 604 and may provide an interface between other application software executing on the computing system(s) 600 and the hardware resources of the computing system(s) 600. More specifically, the O/S 622 may include a set of computer-executable instructions for managing the hardware resources of the computing system(s) 600 and for providing common services to other application programs (e.g., managing memory allocation among various application programs). In certain example embodiments, the O/S 622 may control execution of the other program module(s). The O/S 622 may include any operating system now known or which may be developed in the future including, but not limited to, any server operating system, any mainframe operating system, or any other proprietary or non-proprietary operating system.

The DBMS 624 may be loaded into the memory 604 and may support functionality for accessing, retrieving, storing, and/or manipulating data stored in the memory 604 and/or data stored in the data storage 620. The DBMS 624 may use any of a variety of database models (e.g., relational model, object model, etc.) and may support any of a variety of query languages. The DBMS 624 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computing system(s) 600 is a mobile device, the DBMS 624 may be any suitable lightweight DBMS optimized for performance on a mobile device.

Referring now to other illustrative components of the computing system(s) 600, the input/output (I/O) interface(s) 606 may facilitate the receipt of input information by the computing system(s) 600 from one or more I/O devices as well as the output of information from the computing system(s) 600 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing system(s) 600 or may be separate. The I/O devices may further include, for example, any number of peripheral devices such as data storage devices, printing devices, and so forth.

The I/O interface(s) 606 may also include an interface for an external peripheral device connection such as universal serial bus (USB), FireWire, Thunderbolt, Ethernet port or other connection protocol that may connect to one or more networks. The I/O interface(s) 606 may also include a connection to one or more of the antenna(s) 630 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The computing system(s) 600 may further include one or more network interface(s) 608 via which the computing system(s) 600 may communicate with any of a variety of other systems, platforms, networks, devices, and so forth. The network interface(s) 608 may enable communication, for example, with one or more wireless routers, one or more host servers, one or more web servers, and the like via one or more networks.

The antenna(s) 630 may include any suitable type of antenna depending, for example, on the communications protocols used to transmit or receive signals via the antenna(s) 630. Non-limiting examples of suitable antennas may include directional antennas, non-directional antennas, dipole antennas, folded dipole antennas, patch antennas, multiple-input multiple-output (MIMO) antennas, or the like. The antenna(s) 630 may be communicatively coupled to one or more transceivers 612 or radio components to which or from which signals may be transmitted or received.

As previously described, the antenna(s) 630 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(s) 630 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(s) 630 may be configured to transmit or receive radio frequency signals within any suitable frequency range forming part of the unlicensed portion of the radio spectrum.

The antenna(s) 630 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 612 may include any suitable radio component(s) for—in cooperation with the antenna(s) 630—transmitting or receiving radio frequency (RF) signals in the bandwidth and/or channels corresponding to the communications protocols utilized by the computing system(s) 600 to communicate with other devices. The transceiver(s) 612 may include hardware, software, and/or firmware for modulating, transmitting, or receiving—potentially in cooperation with any of antenna(s) 630—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 612 may further include hardware, firmware, or software for receiving GNSS signals. The transceiver(s) 612 may include any known receiver and baseband suitable for communicating via the communications protocols utilized by the computing system(s) 600. The transceiver(s) 612 may further include a low noise amplifier (LNA), additional signal amplifiers, an analog-to-digital (A/D) converter, one or more buffers, a digital baseband, or the like.

The sensor(s)/sensor interface(s) 610 may include or may be capable of interfacing with any suitable type of sensing device such as, for example, inertial sensors, force sensors, thermal sensors, photocells, and so forth. Example types of inertial sensors may include accelerometers (e.g., MEMS-based accelerometers), gyroscopes, and so forth.

The optional display(s) 614 may be configured to output light and/or render content. The optional speaker(s)/microphone(s) 616 may be any device configured to receive analog sound input or voice data.

It should be appreciated that the program module(s), applications, computer-executable instructions, code, or the like depicted in FIG. 6 as being stored in the data storage 620 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the computing system(s) 600, and/or hosted on other computing device(s) accessible via one or more networks, may be provided to support functionality provided by the program module(s), applications, or computer-executable code depicted in FIG. 6 and/or additional or alternate functionality. Further, functionality may be modularized differently such that processing described as being supported collectively by the collection of program module(s) depicted in FIG. 6 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 6 may be implemented, at least partially, in hardware and/or firmware across any number of devices.

It should further be appreciated that the computing system(s) 600 may include alternate and/or additional hardware, software, or firmware components beyond those described or depicted without departing from the scope of the disclosure. More particularly, it should be appreciated that software, firmware, or hardware components depicted as forming part of the computing system(s) 600 are merely illustrative and that some components may not be present or additional components may be provided in various embodiments. While various illustrative program module(s) have been depicted and described as software module(s) stored in the data storage 620, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A computer-implemented method for block-based iterative one-pass processing on a single block-based hardware component, the method comprising:
receiving input data;
generating a first block including first data points of the input data and a second block including second data points of the input data;
processing, by the single block-based hardware component, all of the first data points in the first block at one time to compute a first mean of the first data points;
computing, by the single block-based hardware component, a first variance value for the first block using the first mean;
storing the first variance value as a cumulative variance value, wherein the cumulative variance value is a running variance value for all blocks that have been processed by the single block-based hardware component;
processing, by the single block-based hardware component, all of the second data points in the second block at one time to compute a second mean of the second data points;
computing, by the single block-based hardware component, a second variance value for the second block using the second mean;
updating, by the single block-based hardware component, the cumulative variance value using the second variance value and a cumulative number of data entries processed; and
outputting a variance for the input data as the cumulative variance value divided by a cumulative number of data points in the first block and the second block.

2. The computer-implemented method of claim 1, further comprising:
iteratively processing, by the single block-based hardware component, additional blocks of the input data until all blocks of the input data have been processed; and
after each subsequent block is processed, updating, by the single block-based hardware component, the cumulative variance value.

3. The computer-implemented method of claim 1, wherein the variance for the input data is determined without performing a second pass of the input data.

4. The computer-implemented method of claim 1, further comprising:
determining, by the single block-based hardware component, a delta value as a difference between the second mean and the first mean, wherein updating the cumulative variance value is further based on the delta value.

5. The computer-implemented method of claim 1, wherein computing the first mean of the first data points further comprises:
computing, by the single block-based hardware component, a first sum of the first data points; and
dividing, by the single block-based hardware component, the first sum of the first data points by a number of entries in the first block.

6. The computer-implemented method of claim 1, wherein computing the first variance value for the first block further comprises:
computing, by the single block-based hardware component, a first sum of data points in the first block; and
computing, by the single block-based hardware component, a sum of squares of a value based on the first sum of data points.

7. The computer-implemented method of claim 1, further comprising automatically performing an action in response to the variance.

8. A system for block-based iterative one-pass processing on a single block-based hardware component, comprising:
at least one processor of the single block-based hardware component; and
at least one memory storing computer-executable instructions, that when executed by the at least one processor, cause the at least one processor to:
receive input data;
generate a first block including first data points of the input data and a second block including second data points of the input data;
process, by the single block-based hardware component, all of the first data points in the first block at one time to compute a first mean of the first data points;
compute, by the single block-based hardware component, a first variance value for the first block using the first mean;
store the first variance value as a cumulative variance value, wherein the cumulative variance value is a running variance value for all blocks that have been processed by the single block-based hardware component;
process, by the single block-based hardware component, all of the second data points in the second block at one time to compute a second mean of the second data points;
compute, by the single block-based hardware component, a second variance value for the second block using the second mean;
update, by the single block-based hardware component, the cumulative variance value using the second variance value and a cumulative number of data entries processed; and
output a variance for the input data as the cumulative variance value divided by a cumulative number of data points in the first block and the second block.

9. The system of claim 8, wherein the at least one memory storing computer-executable instructions further cause the at least one processor to:
iteratively process, by the single block-based hardware component, additional blocks of the input data until all blocks of the input data have been processed; and
after each subsequent block is processed, update, by the single block-based hardware component, the cumulative variance value.

10. The system of claim 8, wherein the variance for the input data is determined without performing a second pass of the input data.

11. The system of claim 8, wherein the at least one memory storing computer-executable instructions further cause the at least one processor to:
determine, by the single block-based hardware component, a delta value as a difference between the second mean and the first mean, wherein updating the cumulative variance value is further based on the delta value.

12. The system of claim 8, wherein computing the first mean of the first data points further comprises:
compute, by the single block-based hardware component, a first sum of the first data points; and
divide, by the single block-based hardware component, the first sum of the first data points by a number of entries in the first block.

13. The system of claim 8, wherein computing the first variance value for the first block further comprises:
compute, by the single block-based hardware component, a first sum of data points in the first block; and
compute, by the single block-based hardware component, a sum of squares of a value based on the first sum of data points.

14. The system of claim 8, wherein the at least one memory storing computer-executable instructions further cause the at least one processor to automatically perform an action in response to the variance.

15. A non-transitory computer-readable medium including computer-executable instructions stored thereon, which when executed by at least one processor of a single block-based hardware component, cause the at least one processor to:
receive input data;
generate a first block including first data points of the input data and a second block including second data points of the input data;
process, by the single block-based hardware component, all of the first data points in the first block at one time to compute a first mean of the first data points;
compute, by the single block-based hardware component, a first variance value for the first block using the first mean;
store the first variance value as a cumulative variance value, wherein the cumulative variance value is a running variance value for all blocks that have been processed by the single block-based hardware component;
process, by the single block-based hardware component, all of the second data points in the second block at one time to compute a second mean of the second data points;
compute, by the single block-based hardware component, a second variance value for the second block using the second mean;
update, by the single block-based hardware component, the cumulative variance value using the second variance value and a cumulative number of data entries processed; and
output a variance for the input data as the cumulative variance value divided by a cumulative number of data points in the first block and the second block.

16. The non-transitory computer-readable medium of claim 15, wherein the at least one memory storing computer-executable instructions further cause the at least one processor to:
iteratively process, by the single block-based hardware component, additional blocks of the input data until all blocks of the input data have been processed; and
after each subsequent block is processed, update, by the single block-based hardware component, the cumulative variance value.

17. The non-transitory computer-readable medium of claim 15, wherein the variance for the input data is determined without performing a second pass of the input data.

18. The non-transitory computer-readable medium of claim 15, wherein the at least one memory storing computer-executable instructions further cause the at least one processor to:
determine, by the single block-based hardware component, a delta value as a difference between the second mean and the first mean, wherein updating the cumulative variance value is further based on the delta value.

19. The non-transitory computer-readable medium of claim 15, wherein computing the first mean of the first data points further comprises:
compute, by the single block-based hardware component, a first sum of the first data points; and
divide, by the single block-based hardware component, the first sum of the first data points by a number of entries in the first block.

20. The non-transitory computer-readable medium of claim 15, wherein computing the first variance value for the first block further comprises:
compute, by the single block-based hardware component, a first sum of data points in the first block; and
compute, by the single block-based hardware component, a sum of squares of a value based on the first sum of data points.
